(19) United States
(12) Patent Application Publication
(10) Pub. No.: US 2024/0082953 A1
(43) Pub. Date: Mar. 14, 2024

(54) METHOD AND LASER PROCESSING APPARATUS FOR PRODUCING A BIPOLAR PLATE

(71) Applicant: TRUMPF Laser GmbH, Schramberg (DE)

(72) Inventors: Jan-Patrick Hermani, Markgroeningen (DE); Martin Stambke, Dunningen (DE)

(21) Appl. No.: 18/515,340

(22) Filed: Nov. 21, 2023

Related U.S. Application Data
(63) Continuation of application No. PCT/EP2022/062449, filed on May 22, 2022.

(30) Foreign Application Priority Data
May 26, 2021 (DE) 10 2021 113 597.4

(51) Int. Cl. B23K 26/24; B23K 26/08

(52) U.S. Cl. CPC B23K 26/24; B23K 26/0876

(57) ABSTRACT

A method for producing a bipolar plate includes providing a first plate element and a second plate element. The first plate element has at least one bead with a longitudinal extent. The method further includes forming a welded connection between the first plate element and the second plate element along the longitudinal extent by using a laser processing beam. The formation of the welded connection includes detecting a geometric feature of the at least one bead located in a transverse direction. The geometric feature is a deepest point or a point of defined depth of the at least one bead. The formation of the welded connection further includes readjusting the laser processing beam in the transverse direction to a position of the detected geometric feature, and welding the first plate element and the second plate element together at the position of the geometric feature.

### CROSS REFERENCE TO RELATED APPLICATIONS

This application is a continuation of International Application No. PCT/EP2022/062449 (WO 2022/248203 A1), filed on May 9, 2022, and claims benefit to German Patent Application No. DE 10 2021 113 597.4, filed on May 26, 2021. The aforementioned applications are hereby incorporated by reference herein.

### FIELD

Embodiments of the present invention relate to a method for producing a bipolar plate comprising at least two plate elements connected to one another. Embodiments of the present invention also relate to a laser processing apparatus for producing a bipolar plate.

### BACKGROUND

A fuel cell can include, for example, of up to 200 bipolar plates, which are joined around the periphery in fluid-tight fashion. Laser beam welding has become established as a joining technology but there is no suitable process sensor system for achieving 100% leaktightness under series production conditions. Possible causes of leakages are, for example, inaccuracies in the clamping technique and the positioning of the laser beam. Individual leakages lead to high reject rates and, among other things, are a reason for the high costs of fuel cell technology.

EP1504482B1 discloses a method for producing a bipolar plate for fuel cell systems, wherein the metal portions are connected by laser beam welding. The plate-shaped metal portions are arranged one on the other without a gap during the laser welding and, to reduce the input of heat during the welding operation, the weld seams are made in the form of linear portions positioned one behind the other but at a distance from one another.

DE102016200387A1 discloses a method for producing a bipolar plate, wherein the separator plates are connected to one another by an integral bond and the energy required for the connection is supplied via respective outer sides of the two separator plates.

DE102005001303B4 likewise discloses a method for joining at least a first metal sheet and a second metal sheet together by means of laser welding.

DE102010021982A1 discloses an arrangement for the hermetically sealed connection of fuel cell bipolar plates by means of laser transmission welding.

A disadvantage of the prior art is that the laser processing beam cannot be guided to a particular position of a geometric feature of a bipolar plate in order to be able to produce fluid-tight bipolar plates. The inability to position the laser processing beam results in high reject rates and a lower output in the production of bipolar plates.

### SUMMARY

Embodiments of the present invention provide a method for producing a bipolar plate comprising at least two plate elements connected to one another. The method includes providing a first plate element and a second plate element. The first plate element has at least one bead with a longitudinal extent. The method further includes forming a welded connection between the first plate element and the second plate element along the longitudinal extent of the at least one bead by using a laser processing beam which advances in the longitudinal extent of the bead. The formation of the welded connection includes detecting a geometric feature of the at least one bead of the first plate-element located in a transverse direction in relation to the longitudinal extent of the at least one bead. The geometric feature is a deepest point of the at least one bead or a point of defined depth of the at least one bead. The formation of the welded connection further includes readjusting the laser processing beam in the transverse direction to a position of the detected geometric feature, and welding the first plate element and the second plate element together by using the laser processing beam at the position of the geometric feature.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a schematic sectional illustration of a first plate element and a second plate element of a bipolar plate in a plane oriented perpendicularly to a longitudinal extent of the first plate element and of the second plate element, according to some embodiments;

FIG. 1B shows a schematic sectional illustration of a first plate element and a second plate element of a bipolar plate in a plane oriented perpendicularly to a longitudinal extent of the first plate element and of the second plate element, according to some embodiments;

FIG. 2a shows a schematic plan view of a plate element according to some embodiments;

FIG. 2b shows an enlarged illustration of the subregion A of the schematic plan view of the plate element according to FIG. 2a; and

FIG. 3 shows a schematic illustration of the laser processing apparatus according to some embodiments.

### DETAILED DESCRIPTION

Embodiments of the present invention provide a method and a laser processing apparatus which make it possible to produce bipolar plates with greater accuracy and in particular with a greater degree of leaktightness than is known from the prior art.

The plate elements of the bipolar plate extend along a longitudinal extent of the beads and a transverse direction, which is perpendicular thereto. The welded connection is formed on the workpiece by a laser processing beam, wherein the high-energy processing beam can be moved in a processing direction relative to the workpiece with a processing speed. In this respect, the processing direction is oriented parallel to the longitudinal extent of the bead. In addition, the laser processing beam can be deflected and/or moved back and forth in a transverse direction, which is oriented transversely and in particular perpendicularly to the processing direction. By moving the laser processing beam back and forth, a zigzag-shaped or serpentine weld seam can be created.

A depth direction is oriented in particular perpendicularly to the transverse direction and to the longitudinal extent of the bead. In this respect, a depth of a bead at a particular position of the bead is to be understood as meaning in particular a distance, oriented in the depth direction, between a top side of the first plate element and this position of the bead.

The detection of a geometric feature located in a transverse direction in relation to the longitudinal extent of the at least one bead, of a deepest point and/or of a point of defined depth of the bead makes it possible to arrange the laser processing beam in positionally accurate fashion. A fluid-tight connection between the first plate element and the second plate element can be produced by means of the exact positioning of the laser processing beam in the bead.

Since the welded connection runs along in the longitudinal extent of the bead, a leaktight cooling channel can form in at least one bead of a plate element. This leads to a reduction in rejects in the production of bipolar plates and a reduction in the testing time of several minutes needed for checking the leaktightness of each bipolar plate.

Furthermore, the accurate positioning of the laser processing beam in the bead makes it possible to improve manufacturing tolerances, as a result of which rejects from manufacture are reduced.

According to embodiments of the present invention, it may be provided that the geometric feature is detected optically and/or contactlessly by means of a measurement beam, in particular by means of an optical coherence tomography (OCT) device.

According to some embodiments, the measurement information detected by means of the optical coherence tomography device includes height information for a measurement point at the respective measurement position, that is to say topographic information of the plate element and/or information regarding the penetration depth of the laser processing beam.

In an alternative, the geometric feature is recorded by means of the optical coherence tomography device coaxially with the laser processing beam.

In one embodiment, it may be provided that the optical coherence tomography device provides a reference beam and the measurement beam, wherein the reference beam is reflected at a reference mirror of the optical coherence tomography device, the measurement beam is reflected at a first plate element, and the reflected reference beam and the reflected measurement beam are superposed to generate an evaluation signal.

In particular, it may be provided that an evaluation signal generated by the optical coherence tomography device comprises information regarding a depth of the bead along the transverse direction.

A depth of the bead at a particular position of the bead is to be understood as meaning in particular a distance, oriented in the depth direction, between a top side of the first plate element and this position of the bead, wherein the depth direction is oriented in particular perpendicularly to the transverse direction and to the longitudinal extent of the bead.

It may be advantageous for the geometric feature of the bead of the first plate element to be the deepest point of the bead and/or a point of defined depth of the bead. This has the advantage that the measurement beam is positioned such that it takes a measurement at a point of defined depth and the laser processing beam is readjusted to the position of defined depth to weld the first and the second plate element together, in order to obtain a satisfactory weld seam.

As an alternative, a symmetry criterion of the bead can be used for the geometric feature. For example, the geometric feature may be a centre of the bead with respect to a direction oriented transversely in relation to the longitudinal extent of the bead.

In one embodiment, it may be provided that the first plate element and the second plate element are arranged so as to be fixed in relation to one another before the welded connection is formed.

Fixing during an upstream method step may be done for example by clamping, tensioning apparatuses or stops and has the advantage that the plate elements can be aligned in relation to one another and correctly positioned before the welded connection is formed.

As an alternative, the first plate element and the second plate element may for example be welded before the welded connection is formed using spot or stitch weld seams, in order to obtain a closely fitted state in relation to one another. The assembly which takes place in advance can be used to counteract interspaces between the first plate element and the second plate element and to enable sufficient weld seams.

In particular, at least one bead of the first plate element and at least one bead of the second plate element are arranged in mirror-inverted fashion in relation to one another, and/or a cavity for forming a channel, in particular a cooling channel, is formed between beads that are adjacent to one another in the transverse direction. However, a trapped wave can also be produced if the multiplicity of beads and webs are not correctly assembled.

Advantageously, the beads of the first plate element and the beads of the second plate element extend in mirror-inverted fashion with respect to the longitudinal extent and in particular parallel to the processing direction.

In one embodiment, for example, it is possible for only one of the plate elements to have beads and for the second plate element to have a planar form.

Webs are formed between two beads which are adjacent in a longitudinal extent. If the first plate element and the second plate element have beads and thus webs in the longitudinal extent, the plate elements are advantageously positioned in relation to one another in an upstream method step such that the one bead of the first plate element and the one web of the second plate element are opposite one another. In this case, there should be no mechanical contact between the web and the bead, with an interspace being counteracted.

Given corresponding prior positioning of a second plate element, the deepest point of a bead of a first plate element is preferably the point of contact with the second plate element and thus the preferred welding position.

It is possible for a welded connection substantially around the periphery to take place in the edge region of the plate elements to provide a fluid-tight cavity. To provide a coolant circuit, the cooling channel between the plate elements may have one or more openings for the feed and/or discharge of coolant.

In a preferred embodiment, the welded connection between the first plate element and the second plate element has a fluid-tight form. This has the advantages that the rejects from the production of the bipolar plates and the testing time of several minutes regarding the leaktightness of the bipolar plates can be reduced.

In particular, a laser processing beam with a wavelength of at least 350 nm and/or at most 1100 nm can be used to weld the first plate element and the second plate element together.

The first and/or the second plate element comprise or are made from a metallic, graphitic, ceramic or polymeric material. For example, at least one of the plate elements may comprise an alloy, for example high-quality steel alloys.

In particular, it may be provided that the first plate element and/or the second plate element have/has a thickness of less than 200 μm, preferably less than 100 μm, preferably less than 75 μm.

In particular, the first plate element and/or the second plate element have/has a thickness of at least 50 μm.

In one embodiment, it may be provided that the measurement beam generated by means of the optical coherence tomography device is moved relative to the plate element and independently of the laser processing beam by means of at least one measurement beam deflection device.

The measurement beam deflection device may be in the form of a scanner or mirror, for example. The movement of the measurement beam independently of the laser processing beam has the advantage that the measurement beam can be controlled independently of the processing beam to any desired position of the plate element, in order to detect geometric features at desired positions. The position of the measurement beam here may be located upstream in front of the laser processing beam (pre-measurement position), coaxially with the laser processing beam (in-measurement position), or downstream following the laser processing beam (post-measurement position), in the processing direction of the laser processing apparatus.

In a preferred embodiment, the measurement beam generated by means of the optical coherence tomography device is arranged at a distance (d) in front of the laser processing beam in a processing direction, wherein the processing direction is oriented parallel to the longitudinal extent of the bead. In this case, the measurement beam is incident at a particular processing point on a plate element temporally before the laser processing beam in the processing direction (pre-measurement position), and detects a region of the plate element that is to be processed.

Advantageously, before the processing by the laser processing beam, information, for example geometric features, in particular depth information, on a plate element is/are detected and the laser processing beam is readjusted to the correspondingly defined point in the bead.

Further advantages of the embodiments of the invention will emerge from the description and the drawings. The embodiments shown and described should not be understood as an exhaustive enumeration, but rather are of an exemplary character for outlining the invention.

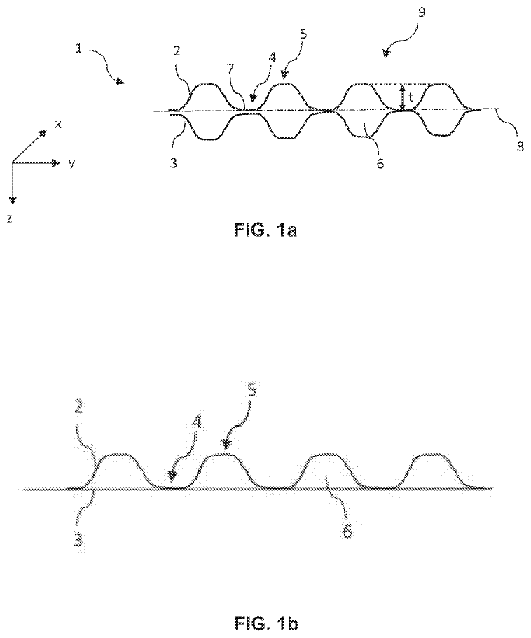

FIG. 1a and FIG. 1b show a schematic sectional illustration of possible embodiments of a first plate element 2 and a second plate element 3 of a bipolar plate 1.

The first plate element 2 and the second plate element 3 are to be welded to one another by a laser processing method. A laser processing apparatus 20 is provided to carry out the laser processing method.

To produce a welded connection by means of the laser processing apparatus 20, the first plate element 2 has a multiplicity of beads 4.

The second plate element 3 may either have a flat or planar form or have beads 4 similar to the first plate element 2.

The beads 4 extend along a longitudinal extent 19. This longitudinal extent 19 is oriented at least approximately parallel to a processing direction x, in which the processing of the first plate element 2 and/or of the second plate element 3 by means of a laser processing beam 11 provided by the laser processing apparatus 20 is to take place.

In particular, the processing direction x is to be understood to mean a main direction and/or an advancement direction, parallel to which the processing of the first plate element 2 and/or of the second plate element 3 by means of the laser processing beam 11 takes place.

The laser processing beam 11 moves in the processing direction x relative to the first plate element 2 during the laser processing method. The laser processing beam 11 can be deflected in a transverse direction y oriented transversely to the processing direction x during the laser processing method.

A web 5, which is oriented at least approximately parallel to the longitudinal extent 19 of the beads 4, is formed between two adjacent beads 4 of a plate element.

Each plate element has a plate top side 9, wherein at least the first plate element 2 also has beads 4 in addition to the plate top side 9. The webs 5 formed between two adjacent beads 4 are part of the plate top side 9. The beads 4 have a depth t with respect to the plate top side 9, wherein the depth direction z extends perpendicularly to the surface where the plate top side 9 is.

The webs 5 likewise extend along the processing direction x. The formation of the beads 4 and webs 5 results in the production of channel structures, in particular cooling channels 6, between the first plate element 2 and the second plate element 3 in the longitudinal extent 19 when the two plate elements are brought together.

Openings, which are not illustrated, for the feed and/or discharge of coolant may be provided in the resulting coolant circuit.

In an exemplary embodiment according to FIG. 1a, the first plate element 2 and the second plate element 3 have beads 4 and a substantially complementary shape which in particular is mirror-inverted with respect to a mirror plane 8. In particular, in this case, in an upstream method step the beads 4 of the first plate element 2 and the webs 5 of the second plate element 3 are arranged opposite one another and the two plate elements 2, 3 are fixed.

For later processing of the two plate elements 2, 3, it is helpful if the two plate elements 2, 3 have a shared mechanical contact surface in relation to one another at least in certain portions.

In the exemplary embodiment according to FIG. 1b, one of the two plate elements 2, 3, in particular the second plate element 3, has a flat form. Since the second plate element 3 does not have any beads 4 or webs 5, upstream positioning of the beads 4 and webs 5 of the two plate elements 2, 3 is not necessary.

The first plate element 2 and the second plate element 3 are connected to one another by a laser weld. In this respect, it is desired for the two plate elements 2, 3 to be welded to one another in fluid-tight fashion, in order to reduce later rejects and testing time regarding the leaktightness of the bipolar plates 1.

The thickness of the first plate element 2 and/or of the second plate element 3 in the unwelded state is less than 200 μm, preferably less than 100 μm, preferably less than 75 μm. Thicknesses of at least 50 μm are possible.

It is possible to produce a bipolar plate 1, which may be a constituent part of a fuel cell arrangement, from the two welded-together plate elements 2, 3.

In the case of fuel cells, usually multiple fuel cells are layered one on top of another to form a fuel cell stack. The individual cells are separated by bipolar plates.

The bipolar plate is distinguished in particular in that it can be produced cost-effectively and also meets high requirements for leaktightness and provides good current conduction through the bipolar plate.

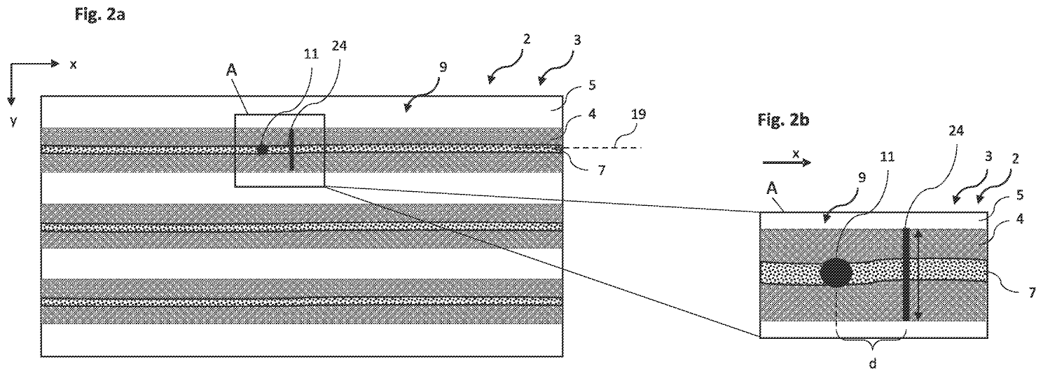

FIG. 2a shows a schematic plan view of a plate top side 9 of a plate element, wherein a detail A of the plate element is illustrated in enlarged fashion in FIG. 2b. The first plate element 2 and/or the second plate element 3, as shown in FIGS. 1a and 1b, have beads 4 which extend along the longitudinal extent 19. Each bead 4 in this case has a geometric feature 7, such as for example a deepest point, in a transverse direction y extending transversely to the longitudinal extent 19.

The deepest point is understood to mean height information, in particular a depth tin the depth direction z, measured from the plate top side 9 to this position inside the bead 4, wherein the depth direction z is oriented in particular perpendicularly to the transverse direction y and to the longitudinal extent 19 of the plate element. The course of the deepest point 7 along the longitudinal extent 19 in a bead 4 may be parallel to the processing direction x. A position of the geometric feature 7 may vary along the longitudinal extent 19 of the bead 4 with respect to the transverse direction y (see FIG. 2b).

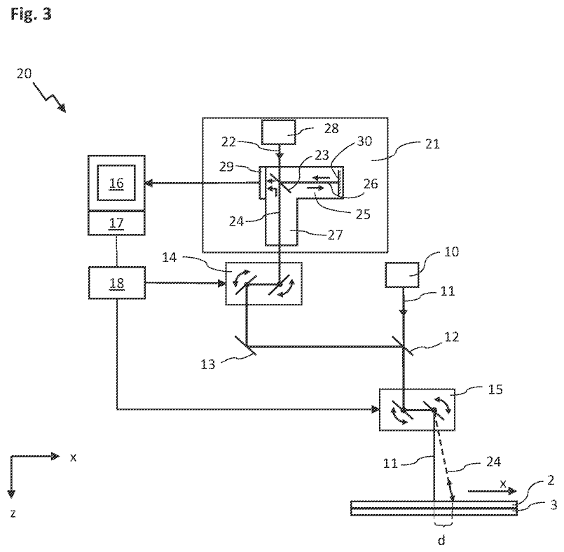

FIG. 3 shows a schematic illustration of a laser processing apparatus 20 according to embodiments of the invention for processing at least a first plate element 2 and a second plate element 3 of a bipolar plate 1. The laser processing apparatus 20 has a laser source 10 for providing a laser processing beam 11 and an optical coherence tomography device 21 for detecting the geometric feature 7.

The laser processing apparatus 20 also in particular comprises an evaluation device 17 for analysing the evaluation signal 16, which comprises information relating to the geometric feature 7 detected, and a control device 18 for readjusting the laser processing beam 11.

The laser source 10 generates the laser processing beam 11, which is directed onto the plate element 2 by means of a laser scanner 15 in order to deflect the laser processing beam 11 on the plate element surface two-dimensionally or else three-dimensionally, if the laser scanner 15 has a Z axis.

As is known, the optical coherence tomography device 21 has an OCT light source (for example super luminescence diode) 28 for generating an OCT beam 22, and a beam splitter 23 for splitting the OCT beam 22 into a measurement beam 24 and a reference beam 26.

The measurement beam 24 is forwarded to a measurement arm 27 and is incident on the plate top side 9 of the plate element 2, at which the measurement beam 24 is at least partially reflected and guided back to the beam splitter 23, which is not transmissive or is partly transmissive in this direction. The reference beam 26 is forwarded to a reference arm 25 and reflected by a mirror 30 at the end of the reference arm 25. The reflected reference beam is likewise guided back to the beam splitter 23.

Lastly, the superposition of the two reflected beams is detected by a spatially resolving detector (OCT sensor) 29 in order, taking account of the length of the reference arm 25, to ascertain height information about the bead 4 of the plate element 2 and/or the current penetration depth of the laser processing beam 11 into the plate element 2. This method is based on the fundamental principle of the interference of light waves and makes it possible to detect height differences along a measurement beam axis measured in micrometres.

Adjoining the measurement arm 27 is an OCT (small-field) scanner 14 in order to deflect the measurement beam 24 two-dimensionally on the plate top side 9 of the plate element 2 and thus to scan a region of the plate top side 9 of the plate element 2 with parallel line scans, for example, in the transverse direction y in relation to the longitudinal extent 19 of the beads 4.

By way of a deflection mirror 13 and a mirror 12 that is arranged in the beam path of the laser processing beam 11, the measurement beam 24 is input coupled in the laser scanner 15 in order to direct the measurement beam 24 onto the plate element 2.

According to the embodiment shown in FIGS. 2a and 2b, the measurement beam 24 advances in front of the laser processing beam 11 in the processing direction x. The measurement beam 24 may be spaced apart from the laser processing beam 11 by a defined distance d, for example between 3 mm and 10 mm. In this case, the distance d extends measured from the centre point of the laser processing beam 11 toward the measurement beam 24. In a further embodiment, the distance d between the laser processing beam 11 and the measurement beam 24 may vary during the detection of the geometric feature 7.

The movable OCT scanner 14 is designed to displace the measurement beam 24 as desired in the transverse direction y to a multiplicity of measurement points at individual measurement positions (see double-headed arrow according to the exemplary embodiment in FIG. 2b). The location of the measurement positions and the number of measurement points can be freely selected here, but should cover at least the width of a bead 4 in the transverse direction y.

The apparatus according to embodiments of the invention operates as follows:

To weld the first plate element 2 and the second plate element 3 together, the plate elements are arranged fixed in relation to one another, for example. According to the exemplary embodiment as shown in FIG. 1a, in a method step upstream of the welding, the first plate element 2 and the second plate element 3 are in particular arranged in mirror-inverted fashion in relation to one another. In this case, mechanical contact between at least one bead 4 of the first plate element 2 and at least one web 5 of the second plate element 3 is produced at least in certain portions.

In a subsequent method step, the laser processing beam 11 and the measurement beam 24 are positioned by means of the laser scanner 15 and OCT scanner 14 on the workpiece, for example the plate top side 9 of the first plate element 2, at a certain distance d from one another. In the process, the measurement beam is incident in front of the laser processing beam along the processing direction x (pre-measurement position) on the plate top side 9 of the plate element 2. The laser processing beam 11 and the measurement beam 24 extend along the processing direction x, wherein the laser processing beam 11 can create a back-and-forth deflection by means of the laser scanner 15 along the processing direction x.

Before the formation of a welded connection between the first plate element 2 and the second plate element 3, the measurement beam 24 is used to detect at least one geometric feature 7, extending in a transverse direction y in relation to the longitudinal extent 19 of the bead 4, in the optical coherence tomography device 21.

After the multiplicity of the measurement points detected by the optical coherence tomography device 21 using the measurement beam 24 are sent to the evaluation unit 17, the evaluation device 17 evaluates the ascertained measurement points with regard to an evaluation signal 16. The evaluation signal 16 contains information about the position of the detected geometric feature 7 in the transverse direction y.

The evaluation device 17 supplies the information about the position of the geometric feature 7 to a control device 18. The control device 18 is connected to the OCT scanner 14 and the laser scanner 15 and readjusts the laser processing beam 11 to the position of the previously detected geometric feature 7, with the result that the first plate element 2 and the second plate element 3 are welded by means of the laser processing beam 11 at the position of the geometric feature 7.

While the first plate element 2 and the second plate element 3 are being welded together, the measurement beam 24 advances in front of the laser processing beam 11 and continuously detects positions of geometric features 7 in a transverse direction y in relation to the longitudinal extent 19 of the bead 4. In the process, evaluation signals 16 containing the information about the position of the geometric feature 7 are continuously transmitted to the control device, with the result that the laser processing beam 11 can be readjusted directly to the position of the geometric feature 7 by means of the laser scanner 15.

The adjustment and positioning of the laser processing beam 11 to/at the position of the geometric feature 7 previously detected by the measurement beam 24 leads to an improvement in the leaktightness of the weld. A possible cause of leakages is inaccuracies in the positioning of the laser beam. As a result of the positioning of the laser processing beam 11 at the position of the geometric feature 7 of a bead 4 of a plate element 2, the laser processing beam 11 is advantageously incident at the contact point with the underlying second plate element 3 and enables a leaktight welded connection.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Bipolar plate
2 First plate element
3 Second plate element
4 Bead
5 Web
6 Cooling channel
7 Geometric feature
8 Mirror plane
9 Plate top side
10 Laser source
11 Laser processing beam
12 Mirror
13 Deflection mirror
14 OCT scanner
15 Laser scanner
16 Evaluation signal
17 Evaluation device
18 Control device
19 Longitudinal extent
20 Laser processing apparatus
21 Optical coherence tomography device
22 OCT beam
23 Beam splitter
24 Measurement beam
25 Reference arm
26 Reference beam
27 Measurement arm
28 OCT light source
29 Detector
30 Mirror
d Distance d
t Depth t
x Processing direction x
y Transverse direction y
z Depth direction z

1. A method for producing a bipolar plate, the method comprising:
providing a first plate element and a second plate element, wherein the first plate element comprises at least one bead with a longitudinal extent, and
forming a welded connection between the first plate element and the second plate element along the longitudinal extent of the at least one bead by using a laser processing beam which advances in the longitudinal extent of the bead, wherein forming the welded connection comprises:
detecting a geometric feature of the at least one bead of the first plate-element located in a transverse direction in relation to the longitudinal extent of the at least one bead, wherein the geometric feature is a deepest point of the at least one bead or a point of defined depth of the at least one bead,
readjusting the laser processing beam in the transverse direction to a position of the detected geometric feature, and
welding the first plate element and the second plate element together by using the laser processing beam at the position of the geometric feature.

2. The method according to claim 1, wherein the geometric feature is detected optically or contactlessly by using a measurement beam.

3. The method according to claim 2, wherein the geometric feature is detected by using an optical coherence tomography device.

4. The method according to claim 3, wherein the optical coherence tomography device provides a reference beam and the measurement beam, wherein the reference beam is reflected at a reference mirror of the optical coherence tomography device, the measurement beam is reflected at the first plate element, and the reflected reference beam and the reflected measurement beam are superposed with each other to generate an evaluation signal.

5. The method according to claim 3, wherein the evaluation signal generated by the optical coherence tomography device comprises information regarding a depth of the at least one bead along the transverse direction.

6. The method according to claim 1, wherein the first plate element and the second plate element are arranged so as to be fixed in relation to one another before the welded connection is formed.

7. The method according to claim 1, wherein the first plate element comprises a plurality of beads in the transverse direction, and the second plate element comprises a plurality of beads in the transverse direction, wherein each respective bead of the first plate element and each corresponding bead of the second plate element are arranged in mirror-inverted fashion in relation to one another, and wherein a cavity for forming a channel is formed between adjacent beads of the first plate element or the second plate element.

8. The method according to claim 1, wherein the welded connection between the first plate element and the second plate element has a fluid-tight form.

9. The method according to claim 1, wherein the laser processing beam has a wavelength of at least 350 nm and at most 1100 nm.

10. The method according to claim 1, wherein the first plate element or the second plate element comprises a metallic material, a graphitic material, a ceramic material, or a polymeric material.

11. The method according to claim 1, wherein the first plate element or the second plate element has a thickness of less than 200 μm.

12. The method according to claim 3, wherein the measurement beam generated by the optical coherence tomography device is moved relative to the first plate element independently of the laser processing beam by using at least one measurement beam deflection device.

13. The method according to claim 3, wherein the measurement beam generated by the optical coherence tomography device is arranged at a distance in front of the laser processing beam in a processing direction, wherein the processing direction is oriented parallel to the longitudinal extent of the at least one bead.

14. An apparatus for producing a bipolar plate having at least two plate elements connected to one another, the apparatus comprising:
a laser source configured to provide a laser processing beam for forming a welded connection between a first plate element and a second plate element along a longitudinal extent of at least one bead of the first plate element;
an optical coherence tomography device configured to, before the formation of the welded connection, detect a geometric feature of the at least one bead of the first plate element located in a transverse direction in relation to the longitudinal extent of the at least one bead, wherein the geometric feature of the at least one bead of the first plate element is a deepest point of the at least one bead or a point of defined depth of the at least one bead; and
a control device for controlling the laser processing beam, wherein the laser processing beam is readjusted in the transverse direction to a position of the detected geometric feature, so that the first plate element and the second plate element are welded together by the laser processing beam at a position of the geometric feature.
